(19) United States
(12) Patent Application Publication
(10) Pub. No.: US 2024/0271928 A1
(43) Pub. Date: Aug. 15, 2024

(54) Method and Device for Measuring a Measurement Object

(71) Applicant: MICRO-EPSILON MESSTECHNIK GMBH & CO. KG, Ortenburg (DE)

(72) Inventors: Gerhard KIRSCHNER, Passau (DE); Daniel SCHWEIZER, Ortenburg (DE); Herbert FUELLMEIER, Egglham (DE)

(21) Appl. No.: 18/564,785

(22) PCT Filed: Apr. 29, 2022
(86) PCT No.: PCT/DE2022/200082

§ 371 Date: Nov. 28, 2023

(30) Foreign Application Priority Data
May 31, 2021 (DE) 10 2021 205 503.6

(51) Int. Cl. G01B 11/24; G01B 11/02

(52) U.S. Cl. CPC G01B 11/24; G01B 11/02

(57) ABSTRACT

A method for measuring a measurement object (1), in particular for determining the position and/or distance of a measurement object (1), for example for measuring the width and/or for measuring the flatness of a measurement object (1), using a measuring system (2) movable along a linear axis (7), wherein the measuring system (2) has at least one sensor (4) and wherein means (9) are arranged to detect a position of a reference point (8) of the measuring system (2), wherein at least one measured value of the measurement object (1) is detected using the sensor (4) and wherein a measurement error of the measured value caused by an inclination of the linear axis (7) by an angle of inclination β is determined and wherein the measured value is corrected by the measurement error.

### CROSS REFERENCE

This application is a national stage entry application under 35 U.S.C. 371 of PCT Patent Application No. PCT/DE2022/200082, filed on 29 Apr. 2022, which claims priority to German Patent Application No. 10 2021 205 503.6, filed on 31 May 2021, the entire contents of each of which are incorporated herein by reference.

### FIELD

The present disclosure relates to a method for measuring a measurement object, in particular for determining the position and/or distance of a measurement object, for example for measuring the width and/or for measuring the flatness of a measurement object, using a measuring system movable along a linear axis, wherein the measuring system has at least one sensor and wherein means are arranged to detect a position of a reference point of the measuring system.

Furthermore, the present disclosure relates to a device for measuring a measurement object, in particular for determining the position and/or distance of a measurement object, for example for measuring the width and/or for measuring the flatness of a measurement object, preferably using a method according to any one of claims 1 to 8, using a measuring system movable along a linear axis, wherein the measuring system has at least one sensor and wherein means are arranged to detect a position of a reference point of the measuring system.

### BACKGROUND

Contactless distance sensors are known from the prior art, which are mounted on a measuring system having a driven linear axis and measure the distance to a measurement object and the position of the measuring system on the linear axis during a traversing movement. The measured value of the sensor (for example, distance or edge position) and the sensor position or the position of a reference point of the measuring system arranged at a defined distance to the sensor, which thus moves uniformly on the linear axis, are detected synchronously. Edge positions and distances to measurement objects can be measured in this way. The edges of the measurement objects or the distances to the measurement objects can be contactlessly detected using optical sensors such as triangulation sensors, confocal sensors, or optical micrometers. Depending on the sensor type and measuring task, different system arrangements can be used. For one-sided measurement, one axis above or below the measurement object is sufficient. If transmitter and receiver are arranged opposite to one another in the sensor, either a C-frame having one axis or an O-frame construction having two axes is used. With the O-frame concept, it is important to ensure that the transmitter and receiver of the sensor (each installed on opposite axes) are moved synchronously. With the C-frame concept, the entire C-frame is usually moved on a linear axis.

The problem with the known systems is that different sources of error exist, which result in the determined measured values being error-prone.

### SUMMARY

The present disclosure is therefore based on the object of designing and refining a method and a device for measuring a measurement object of the type mentioned at the outset in such a way that precise measurement is possible in a simple manner.

According to the present disclosure, the above-mentioned object is achieved, in an embodiment, with respect to the method by the features of claim 1. A method is thus provided for measuring a measurement object, in particular for determining the position and/or distance of a measurement object, for example for measuring the width and/or for measuring the flatness of a measurement object, using a measuring system movable along a linear axis, wherein the measuring system has at least one sensor and wherein means are arranged to detect a position of a reference point of the measuring system, wherein at least one measured value of the measurement object is detected using the sensor and wherein a measurement error of the measured value caused by an inclination of the linear axis by an angle of inclination β is determined and wherein the measured value is corrected by the measurement error.

The above-mentioned object is achieved, in an embodiment, with respect to the device by the features of claim 9. A device is thus provided for measuring a measurement object, in particular for determining the position and/or distance of a measurement object, for example for measuring the width and/or for measuring the flatness of a measurement object, using a measuring system movable along a linear axis, wherein the measuring system has at least one sensor and wherein means are arranged to detect a position of a reference point of the measuring system, wherein at least one measured value of the measurement object is detected using the sensor and wherein a measurement error of the measured value caused by an inclination of the linear axis by an angle of inclination β is determined and wherein the measured value is corrected by the measurement error.

It was first recognized according to the present disclosure that the position of an integrated sensor is distorted by an inclination (rotation) of the measuring system on or with a linear axis out of its horizontal position. This unwanted position change of the sensor system—and thus unwanted displacement of the measuring spot on the measurement object—in different positions of the linear axis results in measurement errors, for example when measuring width (evaluation of the sensor values in the direction of the linear axis) or when measuring flatness with one-sided distance measurement (evaluation of sensor values in the vertical direction to the linear axis).

In a further manner according to the present disclosure, it has been recognized that a measurement error caused by an inclination of the linear axis can be compensated for if the angle of inclination and the position of a reference point of the measuring system in relation to the measurement object are known. The resulting change in position of the measuring spot on the measurement object can be compensated for by a correction unit, for example a computer having appropriate software. To measure the width of the measurement object, it is sufficient to only consider the horizontal position change in the traversing direction. The inclination can mean an absolute inclination of the entire linear axis, or a local inclination, caused for example by a deflection or curvature of the linear axis. To simplify the further description of the present disclosure, the absolute inclination of the linear axis is always represented hereinafter.

Specifically, it is conceivable that the measuring system is mounted on at least one driven linear axis. Alternatively or additionally, the measuring system can have a frame on which the at least one sensor is arranged. The frame can be a C-frame with one axis, an O-frame with two axes, or any other frame, namely according to the measuring task to be fulfilled. With an O-frame, the transmitter and the receiver of the sensor could each be installed on opposite linear axes and moved synchronously. With a C-frame, the entire C-frame could be moved on a single linear axis.

Furthermore, the means for detecting a position of a reference point can be a position encoder of the linear axis. For example, the position of the reference point can be determined absolutely via an incremental magnetic tape. Any other sensor systems can be used here.

Other measuring tasks are also conceivable for the method according to the present disclosure and the device according to the present disclosure, such as a flatness measurement, preferably using a C-frame. The inclination of the linear axis also influences the measured value of the sensor here—but this time the position change in height (vertical measurement) is important. This height change can also be corrected if the C-frame dimensions and angle of inclination(s) of the linear axis are known, for example by a correction unit having appropriate software. It is also conceivable that vertical measurement errors and horizontal measurement errors are corrected at the same time.

The measurement uncertainty caused by the inclination of the linear axis essentially depends on the following factors:
on the flatness (=inclination) of the linear axis
on the height difference of the linear axis to the measurement object
on the horizontal distance of the measuring position to the slide of the linear axis

The term “angle of inclination” describes a linear axis inclination—which thus results in an inclination of the measuring system—in the extension direction or opposite to the extension direction of the linear axis.

In an embodiment, a horizontal measured value of the measurement object is detected, which indicates a position in the extension direction of the linear axis. Alternatively or additionally, a vertical measured value of the measurement object can be detected, which indicates a position in the direction perpendicular to the extension direction of the linear axis. In this disclosure, the terms “horizontal” and “vertical” do not describe an absolute orientation relative to the direction of the gravitational force, but an orientation relative to the extension direction or movement direction of the linear axis. The detection of horizontal measured values can therefore be used to determine the width of a measurement object, whereas the detection of vertical measured values can be used to determine the flatness of a measurement object.

The at least one sensor can, in an embodiment, be a contactless sensor, in particular an optical sensor, such as a triangulation sensor, a confocal sensor, or an optical micrometer. The optical micrometer can, for example, determine the dimension and position of the measurement object without contact using the principle of shading or light quantity measurement.

According to an embodiment, a horizontal measurement error pₕ of the horizontal measured value can be determined using the following formula:

$${p}_{h} = r \cdot sin ( β )$$

wherein r is the vertical distance between the linear axis and the measurement object. A corresponding correction can be implemented in a particularly simple manner.

In a particular embodiment, a horizontal measurement error p_{h,ges} of the horizontal measured value can be determined using the following formulas:

$${p}_{1} = r \cdot sin ( β )$$

$${p}_{2} = a - a \cdot cos ( β )$$

$${p}_{h , ges} = {p}_{1} - {p}_{2}$$

wherein r is the vertical distance between the linear axis and the measurement object and wherein a is the horizontal distance between an edge of the measurement object and the reference point. This allows a particularly exact determination of the measurement error and thus the correction of the measured value, so that a precise measurement of the measurement object is possible.

According to a further embodiment, a vertical measurement error pᵥ of the vertical measured value can be determined using the following formula:

$${p}_{v} = r - r \cdot cos ( β )$$

wherein r is the vertical distance between the linear axis and the measurement object. A corresponding correction can be implemented in a particularly simple manner.

In a particular embodiment, a vertical measurement error p_{v,ges} of the vertical measured value can be determined using the following formula:

$${p}_{3} = r - r \cdot cos ( β )$$

$${p}_{4} = a \cdot sin ( β )$$

$${p}_{v , ges} = {p}_{3} + {p}_{4}$$

wherein r is the vertical distance between the linear axis and the measurement object and wherein a is the horizontal distance between an edge of the measurement object and the reference point. The calculation of the vertical measurement error using the above formulas is extremely exact, which significantly improves the precision of the measurement of the measurement object.

In a further embodiment, the angle of inclination of the linear axis can be determined at defined measuring points. In general, a one-time (or occasional) determination of the angle of inclination may be sufficient. However, it is conceivable that the inclination course of the linear axis changes over time due to various factors (screwing points of the axis, changes in the substructure of the axis, for example due to temperature influences, . . . ). It can therefore be advantageous to repeatedly determine the angle of inclination of the linear axis. An inclination sensor, which is arranged on the measuring system, can be used for this purpose. Inclination sensors of any design are conceivable, insofar as they ensure the necessary resolution and accuracy for the measurement.

There are several options for detecting the angle of inclination of linear axes:
If an inclination sensor can detect the inclination change during the movement of the linear axis, the inclination value of the linear axis can be detected synchronously with the position values of the reference point and the measured values of the sensor. The measured values can then be corrected in an advantageous manner according to the above formulas. If uneven movements of the measuring system on the linear axis (e.g. vibrations, accelerations, etc.) influence the measurement accuracy of the inclination sensor, the detection of the angle of inclination could be omitted during the movement of the linear axis.
If the inclination sensor can only correctly detect the inclination change when it is at a standstill, the angle of inclination of the linear axis could be detected in a fixed grid (for example every 15 cm) at defined measuring points when it is at a standstill. Based on the measuring points, a suitable function could be determined that represents the change in the angle of inclination as a function of the position of the reference point of the measuring system on the linear axis. This function can then be used during the measurement run to determine the angle of inclination as a function of the position of the reference point. The determination of the measuring points can preferably be repeated at regular time intervals.

It is to be noted that the method according to the present disclosure also has an embodiment according to the device. The device according to the present disclosure can have the corresponding features and advantages described with respect to the method. Likewise, features and advantages of the device according to the present disclosure having an embodiment according to the method can be part of the method according to the present disclosure.

There are then various possibilities for advantageously designing and refining the teaching of the present disclosure. For this purpose, reference is made, on the one hand, to the claims subordinate to claims 1 and 9 and, on the other hand, to the following explanation of exemplary embodiments of the present disclosure with reference to the drawings. In connection with the explanation of the exemplary embodiments of the present disclosure with reference to drawings, preferred embodiments and refinements of the teachings are also explained in general.

### BRIEF DESCRIPTION OF THE SEVERAL VIEWS OF THE DRAWINGS

FIG. 1 shows a schematic representation of an exemplary embodiment of a device according to the present disclosure for carrying out the method according to the present disclosure,

FIGS. 2a to 2c show schematic representations of the effect of an inclination of the linear axis on the horizontal measured value,

FIG. 3 shows a schematic representation of an approximation of the horizontal measurement error when the linear axis is inclined,

FIG. 4 shows a schematic representation of the real horizontal measurement error when the linear axis is inclined,

FIG. 5 shows a schematic representation of an illustration of the angle of inclination,

FIG. 6 shows the change in the angle of inclination of a linear axis measured over several days, and

FIG. 7 shows a schematic representation of the real vertical measurement error when the linear axis is inclined.

To improve clarity, not all elements in the figures are always provided with a reference numeral, wherein the same elements are identified by the same reference numerals in the figures.

### DETAILED DESCRIPTION OF THE DISCLOSURE

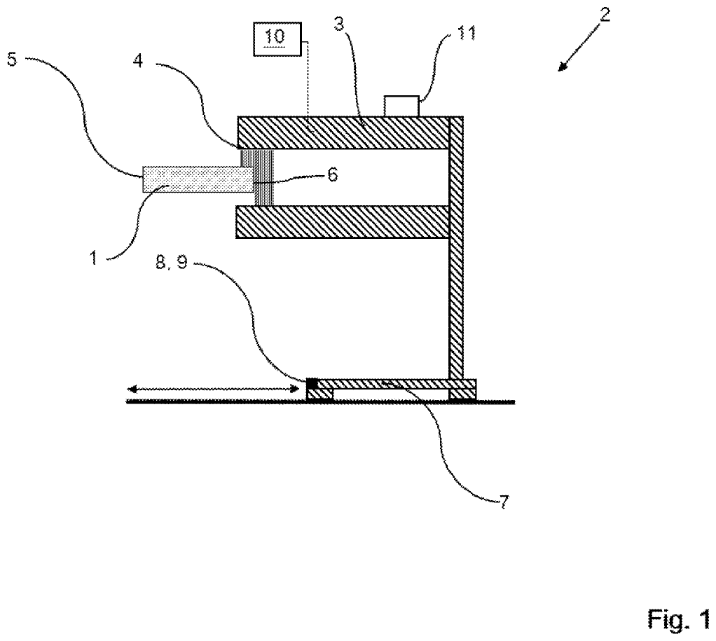

With FIG. 1, the measurement errors to be compensated for by the present disclosure are explained using a measurement of width. For a measurement of flatness, a sensor system for distance measurement would have to be outlined in FIG. 1. Instead of the horizontal measuring direction, the vertical measuring direction would have to be considered instead.

FIG. 1 shows an exemplary embodiment of a device for measuring the width of a measurement object 1. The device has a measuring system 2 having a C-frame 3 and a sensor 4, which in this exemplary embodiment is designed as an optical micrometer. The sensor 4 detects the relative edges 5, 6 of the measurement object 1 to the C-frame 3 in a horizontal measuring direction, i.e., along the extension direction of the linear axis 7. In order to determine the position of the sensor 4, a reference point 8 is provided, the position of which on the linear axis 7 is determinable using suitable means 9 for detecting the position. In this exemplary embodiment, the position of the reference point 8 can be determined absolutely using an incremental magnetic tape 9, which is thus used as a means 9 for detecting the position. Other embodiments of the means 9 are conceivable, for example a sensor, in particular an optical sensor or a cable pull sensor. If both position values are detected synchronously during the measurement run, the absolute edge position of the measurement object can be determined by simply adding the two values.

The difference between the measured values of the sensor 4, i.e., the measured positions of the two edges 5, 6 of the measurement object 1, corresponds to the width of the measurement object 1, wherein the latter must not be moved during the width measurement.

Furthermore, a correction unit 10 is shown in FIG. 1, which can be, for example, a computer having appropriate software. The correction unit 10 is used to correct measurement errors caused by an inclination of the linear axis 7 by an angle of inclination β. In order to detect the angle of inclination β, the measuring system 2 can have an inclination sensor 11, wherein this does not necessarily have to be the case. To simplify the illustration, the correction unit 10 and the inclination sensor 11 are not shown in the other figures, but can nevertheless be provided therein.

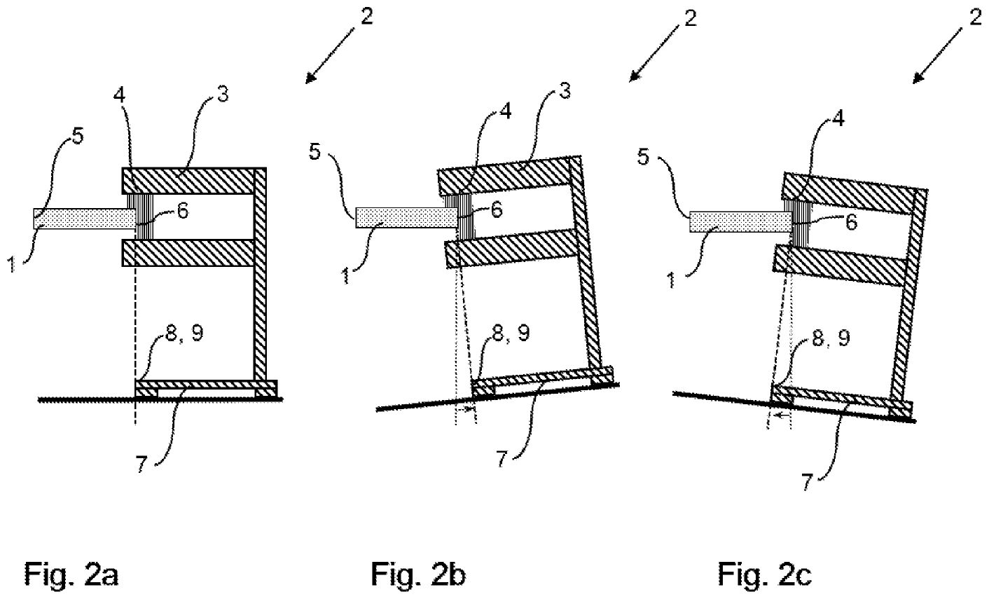

The horizontal measurement error is illustrated in FIGS. 2a to 2c, wherein three situations are shown on the linear axis 7:
Ideal alignment (FIG. 2a): the actual position of the edge 6 of the measurement object 1 and the detected position of the edge 6 of the measurement object 1 on the linear axis 7 correspond.
Inclination forward (FIG. 2b): the detected position of the edge 6 of the measurement object 1 is trailing behind the actual position of the edge 6 of the measurement object 1.
Inclination backward (FIG. 2c): the detected position of the edge 6 of the measurement object 1 is leading in front of the actual position of the edge 6 of the measurement object 1.

If the angle of inclination β and the geometric position of the measurement object 1 are known, the position deviation can be determined in the manner according to the present disclosure.

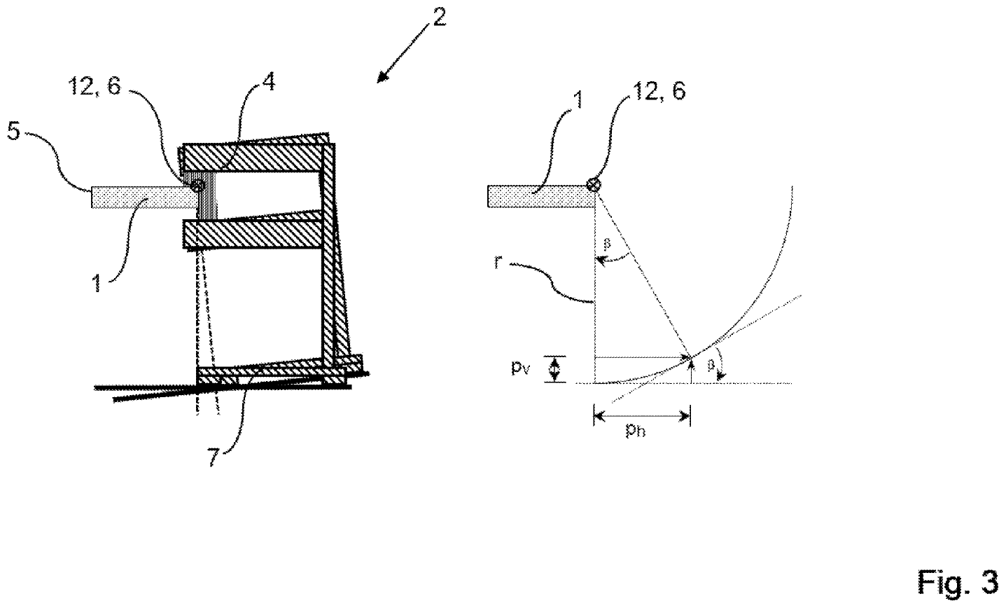

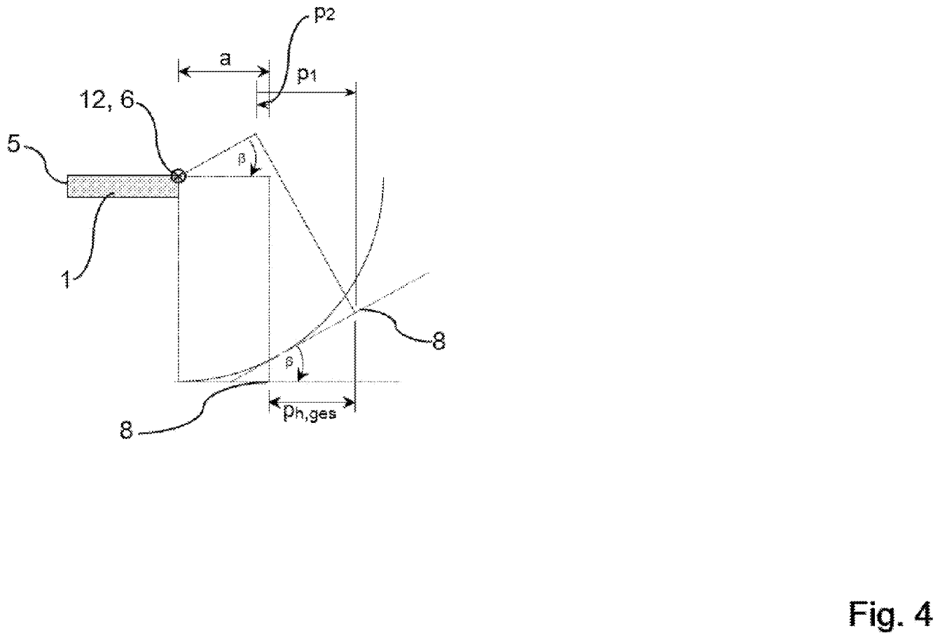

FIG. 3 shows the basic error in simplified form. The edge 6 of the measurement object 1 was chosen as the pivot point 12 for the inclination. The expected horizontal measurement error pₕ is plotted in the direction of the linear axis 7. The representation is simplified in that the detected measured value of the edge 6 of the sensor 4 and the detection of the reference point 8 (for example sensor of the magnetic tape on the slide of the linear axis 7) lie geometrically one above another. If this is not the case, the result is a slightly different calculation, which is shown in FIG. 4. Only the horizontal position changes are shown in FIG. 4.

According to FIG. 3, the corresponding inclination of the measuring system 2 caused by the angle of inclination β of the linear axis 7 can be split into two movements:
The rotational movement causes a vertical height change (difference measurement object 1−linear axis 7), which can be ignored for a width measurement. It comes into play when measuring flatness, as the measuring distance is then distorted due to the inclination.
The rotational movement causes a horizontal distance change between the measured value of the edge 6 detected by the sensor 4 and the reference point 8 of the linear axis 7.

If the angle of inclination β and the height difference r between the linear axis 7 and the measurement object 1 are known, the position changes in the horizontal direction, i.e., the horizontal measurement error pₕ, and the position change in the vertical direction, i.e., the vertical measurement error pᵥ, can be calculated as follows:

$${p}_{h} = r \cdot sin ( β )$$

$${p}_{v} = r - r \cdot cos ( β )$$

If the distance between the edge 6 of the measurement object 1 and the reference point 8 on the measuring system 2 is also taken into consideration when determining the inclination, then FIG. 4 shows the situation schematically.

The horizontal measurement error p_{h,ges} can be determined by two movements. As shown in FIG. 3, the height difference r causes the majority of the position change p₁. The distance a between the edge 6 of the measurement object 1 and the reference point 8 causes a second horizontal position change p₂. The difference between the two position changes results in the total horizontal measurement error p_{ges}:

$${p}_{1} = r \cdot sin ( β )$$

$${p}_{2} = a - a \cdot cos ( β )$$

$${p}_{h , ges} = {p}_{1} - {p}_{2}$$

From the formula for p₂ it can be seen that this distance value can be neglected for small angles of inclination β.

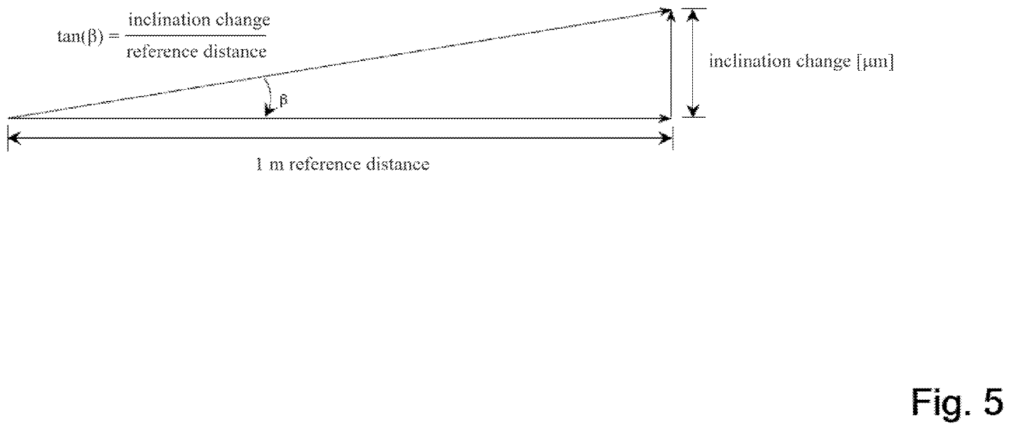

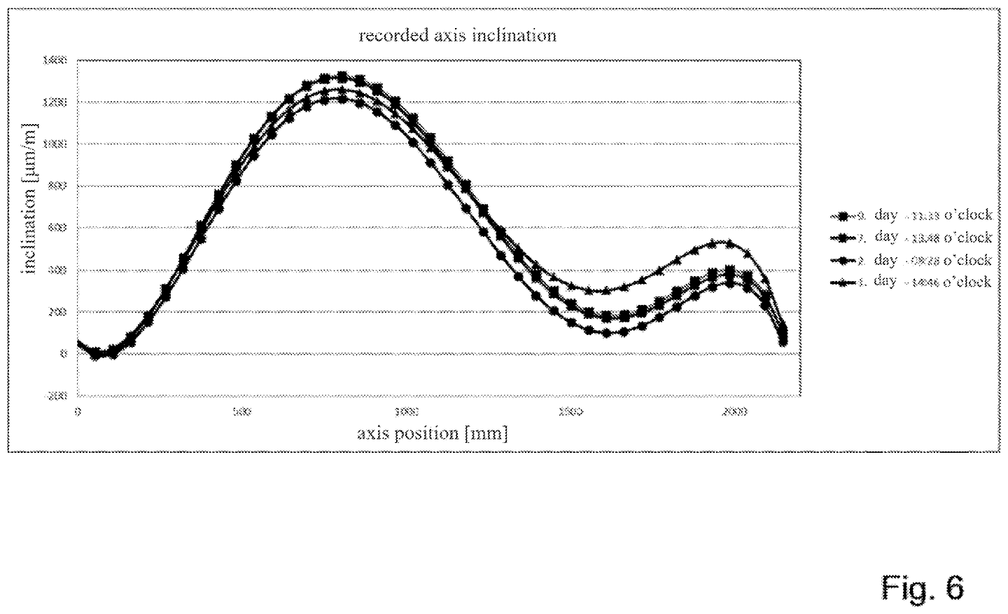

FIG. 6 shows the measured inclination change of a linear axis 7 of 2.2 m length. The inclination of the linear axis 7 was measured over several days. Typically, inclination values are given in degrees [°]. Since the expected values of an inclination change on a linear axis 7 are relatively small and in order to get a better idea of the expected error, [μm/m] was chosen as the unit, i.e., the inclination change in [μm] per meter and reference distance are selected to be plotted against one another. If the height difference between the edge 5, 6 of the measurement object 1 and the linear axis is to be 1 m, the expected inclination error is shown in [μm]. FIG. 5 illustrates the relationship. An inclination of 600 μm/m corresponds to an angle of approximately 0.057°.

Depending on where the edges 5, 6 lie, the angle of inclination β of the linear axis 7 influences the result of a width measurement to a greater or lesser extent. The method according to the present disclosure and the device according to the present disclosure can be used to correct the measured values of the positions of the edges 5, 6 and thus minimize the expected measurement uncertainty.

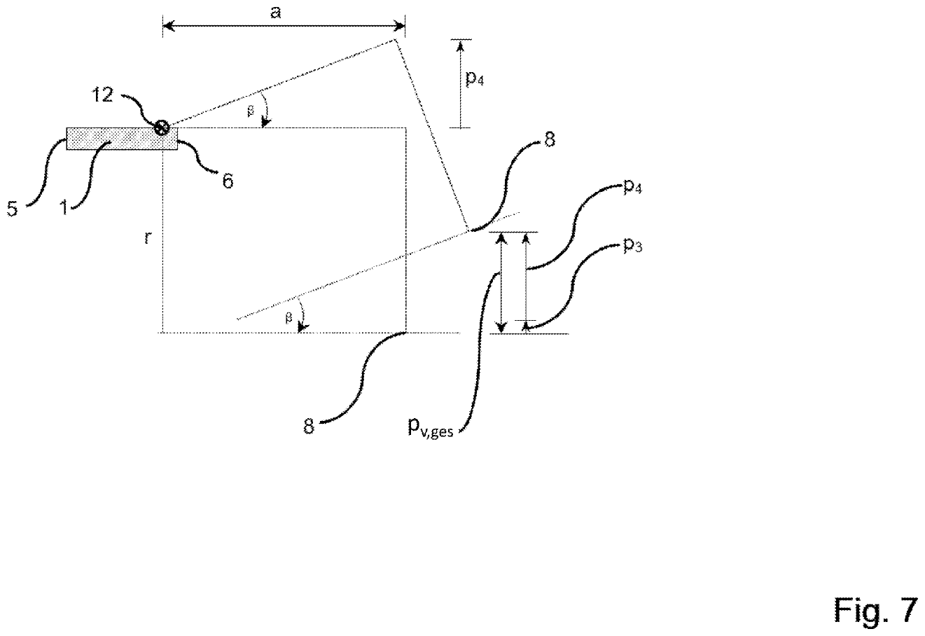

The vertical measurement error pᵥ, caused by the angle of inclination β of a linear axis, is already shown in FIG. 3. The largest part of the measurement uncertainty is caused by the horizontal distance a between the measuring position on the measurement object 1 and reference point 8 on the linear axis. The relationship is shown in FIG. 7. The edge 6 on the measurement object 1 has again been selected as the measurement position as the virtual pivot point 12.

The vertical measurement error pᵥ is shown in FIG. 3, which can be determined as follows:

$${p}_{v} = r - r \cdot cos ( β ) = {p}_{3}$$

In addition, the horizontal distance a between the edge 6 of the measurement object 1 and the reference point 8 causes a further vertical position change p₄. This can be calculated by the following formula:

$${p}_{4} = a \cdot sin ( β )$$

The total vertical position change p_{v,ges}, caused by the axis inclination, can be determined by adding the two values p₃ and p₄:

$${p}_{v , ges} = {p}_{3} + {p}_{4}$$

With known angle of inclination β of the linear axis 7 and known geometric dimensions of the measuring system in relation to the measuring position, the resulting vertical measuring error p_{v,ges} can thus be calculated and corrected.

To avoid repetitions with regard to further advantageous embodiments of the device according to the present disclosure and the method according to the present disclosure, reference is made to the general part of the description and to the appended claims.

Finally, it should be expressly noted that the above-described exemplary embodiments of the device according to the present disclosure and of the method according to the present disclosure are used solely to explain the claimed teaching, but do not restrict it to the exemplary embodiments.

### LIST OF REFERENCE NUMERALS

1 measurement object
2 measuring system
3 frame
4 sensor
5 edge (measurement object)
6 edge (measurement object)
7 linear axis
8 reference point
9 means for position detection
10 correction unit
11 inclination sensor
12 pivot point
β angle of inclination
r distance (linear axis−measurement object)
a distance (measuring point−reference point)

1. A method for measuring a measurement object, in particular for determining the position and/or distance of a measurement object, for example for measuring the width and/or for measuring the flatness of a measurement object, comprising:
using a measuring system movable along a linear axis, wherein the measuring system has at least one sensor;
wherein means are arranged to detect a position of a reference point of the measuring system;
wherein at least one measured value of the measurement object is detected using the sensor;
wherein a measurement error of the measured value caused by an inclination of the linear axis by an angle of inclination β is determined;
wherein the measured value is corrected by the measurement error.

2. The method according to claim 1, wherein a horizontal measured value of the measurement object is detected, which indicates a position in the extension direction of the linear axis and/or in that a vertical measured value of the measurement object is detected, which indicates a position in the direction perpendicular to the extension direction of the linear axis.

3. The method according to claim 2, wherein a horizontal measurement error pₕ of the horizontal measured value is determined using the formula
$${p}_{h} = r \cdot sin ( β )$$
wherein r is the vertical distance between the linear axis and the measurement object.

4. The method according to claim 2, wherein a horizontal measurement error p_{h,ges} of the horizontal measured value is determined using the formulas
$${p}_{1} = r \cdot sin ( β )$$
$${p}_{2} = a - a \cdot cos ( β )$$
$${p}_{h , ges} = {p}_{1} - {p}_{2}$$
wherein r is the vertical distance between the linear axis and the measurement object and wherein a is the horizontal distance between an edge of the measurement object and the reference point.

5. The method according to claim 2, wherein a vertical measurement error pᵥ of the vertical measured value is determined using the formula
$${p}_{v} = r - r \cdot cos ( β )$$
wherein r is the vertical distance between the linear axis and the measurement object.

6. The method according to claim 2, wherein a vertical measurement error p_{v,ges} of the vertical measured value is determined using the formulas
$${p}_{3} = r - r \cdot cos ( β )$$
$${p}_{4} = a \cdot sin ( β )$$
$${p}_{v , ges} = {p}_{3} + {p}_{4}$$
wherein r is the vertical distance between the linear axis and the measurement object and wherein a is the horizontal distance between an edge of the measurement object and the reference point.

7. The method according to claim 1, wherein the angle of inclination β of the linear axis is determined via an inclination sensor of the measuring system.

8. The method according to claim 1, wherein the angle of inclination β of the linear axis is determined at defined measuring points.

9. A device for measuring a measurement object, in particular for determining the position and/or distance of a measurement object, for example for measuring the width and/or for measuring the flatness of a measurement object, comprising:
a measuring system movable along a linear axis, wherein the measuring system (2) has at least one sensor;
means arranged to detect a position of a reference point of the measuring system;
wherein at least one measured value of the measurement object is measurable using the sensor and wherein a measurement error of the measured value caused by an inclination of the linear axis by an angle of inclination β is determinable by a correction unit and wherein the measured value is correctable by the measurement error by the correction unit.

10. The device according to claim 9, wherein an inclination sensor for determining the angle of inclination β of the linear axis is arranged on the measuring system.
